(19) United States
(12) Patent Application Publication
(10) Pub. No.: US 2017/0162016 A1
(43) Pub. Date: Jun. 8, 2017

(54) SECURITY TAG DETECTION IN A MONITORING ZONE

(71) Applicant: Checkpoint Systems, Inc., Thorofare, NJ (US)

(72) Inventor: Daniel J. Olson, Voorhees, NJ (US)

(21) Appl. No.: 14/962,118

(22) Filed: Dec. 8, 2015

(51) Int. Cl. G08B 13/24

(52) U.S. Cl. CPC G08B 13/2482

(57) ABSTRACT

A non-deactivated tag monitor may include processing circuitry configured to receive alerting criteria. The alerting criteria may include a first set of identification information associated with at least one tag, the at least one tag having an activated and deactivated state where transitioning from the activated and deactivated state occurs at a point of sale prior to exiting the retail space. The tag may be configured to be monitored in a first monitoring zone associated with a retail space. The processing circuitry may be further configured to: receive a second set of identification information associated with a non-deactivated tag detected by at least one tag reader positioned in a second monitoring zone, the second monitoring zone being established outside the retail space; and compare the second set of identification information to the alerting criteria.

### TECHNICAL FIELD

Various example embodiments relate generally to retail theft detection and deterrent and merchandise protection devices and methods.

### BACKGROUND

Security devices may be attached to individual products in order to deter or prevent theft from retail establishments. In some cases, the security devices include tags or other such components that can be wirelessly detected by gate devices at entrances and exits to a retail space. When the security device passes through or proximate to the gate device, an alarm may be generated. The alarm may, in some instances, be an audible alarm that is emitted locally by the security device affixed to the protected product and/or emitted by sounders associated with the gate devices. To avoid sounding the alarms when a product is properly purchased, the security device may be removed or deactivated by store personnel. For example, a key may be provided at the point of sale terminal which facilitates removal of the security device. Alternatively, the security device may be deactivated by store personnel using a deactivation device that, in some instances, sends a signal to the security device to inhibit the device's ability to trigger an alarm when the corresponding products are purchased. However, due to store error or theft, a product may occasionally leave a retail establishment or store without the security device being removed or deactivated.

### BRIEF SUMMARY OF SOME EXAMPLES

Some example embodiments may provide a non-deactivated tag monitor that is configured to issue alerts when a non-deactivated security tag is detected in a monitoring zone located outside a retail space. In some cases, the non-deactivated tag monitor may be configured to provide trend analysis for theft deterrent and detection measures.

In one example embodiment, a non-deactivated tag monitor may include processing circuitry configured to receive alerting criteria. The alerting criteria may include a first set of identification information associated with at least one tag, the at least one tag having an activated and deactivated state, where transitioning from the activated and deactivated state occurs at a point of sale prior to exiting the retail space. The tag may be configured to be monitored in a first monitoring zone associated with a retail space. The processing circuitry may be further configured to: receive a second set of identification information associated with a non-deactivated tag detected by at least one tag reader positioned in a second monitoring zone, the second monitoring zone being established outside the retail space; and compare the second set of identification information to the alerting criteria.

According to another example embodiment, a method of monitoring a non-deactivated tag is provided. The method may include receiving alerting criteria. The alerting criteria may include a first set of identification information associated with at least one tag, the at least one tag having an activated and deactivated state, where transitioning from the activated and deactivated state occurs at a point of sale prior to exiting the retail space. The tag may be configured to be monitored in a first monitoring zone associated with a retail space. The method may further include: receiving a second set of identification information associated with a non-deactivated tag detected by at least one tag reader positioned in a second monitoring zone, the second monitoring zone being established outside the retail space; comparing the second set of identification information to the alerting criteria; and, initiating an alerting response in response to the comparison of the set of identification information to the alerting criteria.

According to another example embodiment, a system for monitoring tags is provided. The system may include a plurality of tag readers associated with a second monitoring zone, and a non-deactivated tag monitor. The non-deactivated tag monitor may include processing circuitry configured to receive alerting criteria. The alerting criteria may include a first set of identification information associated with at least one tag. The at least one tag may have an activated and deactivated state, where transitioning from the activated and deactivated state occurs at a point of sale prior to exiting the retail space. The tag may be configured to be monitored in a first monitoring zone associated with a retail space. The process circuitry may be further configured to: receive a second set of identification information associated with a non-deactivated tag detected by at least one tag reader positioned in a second monitoring zone, the second monitoring zone being established outside the retail space; compare the second set of identification information to the alerting criteria; and initiate an alerting response in response to the comparison of the set of identification information to the alerting criteria.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a conceptual diagram of monitoring zones located outside a group of retail spaces according to an example embodiment;

FIG. 2 illustrates a conceptual diagram of monitoring zones located outside a group of retail spaces according to a further example embodiment;

FIG. 3 illustrates a block diagram of a monitoring network that may be employed to detect security tags, that may be placed on products, that enter monitoring zones located outside a retail space in accordance with an example embodiment;

FIG. 4 illustrates a Hock diagram of a non-deactivated tag monitor according to an example embodiment;

FIG. 5 illustrates a block diagram of a monitoring network that may be employed to detect security tags, that may be placed on products that enter monitoring zones located outside a retail space in accordance with a further example embodiment;

FIG. 6 illustrates a block diagram of a system controller according to an example embodiment;

FIG. 7 illustrates a block diagram showing a control flow representative of an algorithm executable at a non-deactivated tag monitor in accordance with an example embodiment; and

FIG. 8 illustrates a block diagram of a method of determining when a security tag in a monitoring zone located outside a retail space should be grouped in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As used herein, the terms “component,” “module,” and the like are intended to include a computer-related entity, such as but not limited to hardware, firmware, or a combination of hardware and software. For example, a component or module may be, but is not limited to being, a process running on a processor, a processor, an object, an executable, a thread of execution, and/or a computer. By way of example, both an application running on a computing device and/or the computing device can be a component or module. One or more components or modules can reside within a process and/or thread of execution and a component/module may be localized on one computer and/or distributed between two or more computers. In addition, these components can execute from various computer readable media having various data structures stored thereon. The components may communicate by way of local and/or remote processes such as in accordance with a signal having one or more data packets, such as data from one component/module interacting with another component/module in a local system, distributed system, and/or across a network such as the Internet with other systems by way of the signal. Each respective component/module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the components/modules described herein, Furthermore, in the context of this disclosure, the term “module” should not be understood as a nonce word to identify any generic means for performing functionalities of the respective modules. Instead, the tern “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Theft deterrent devices or other such trackable devices or tags are often affixed to products in a retail space (e.g., a retail store) in order to deter theft and thereby reduce losses incurred by retailers. An example of such a tag is an RFID tag. If products are outfitted with a tag, the movement of the products may be detected or tracked. Alternatively or additionally, inventory counting can be performed in an automated or semi-automated way by leveraging the tags affixed to the products. Tags may be used to ensure that the products are not removed from the retail space without proper point of sale processing. However, according to some example embodiments, a tag may not be physically deactivated (e.g., damaged in such a way that it is no longer readable), but rather virtually deactivated (e.g., in a database) where the tag is still readable but has been logged in a database as having been properly purchased. As used herein, the term “deactivated” refers to virtual deactivation, where a product was properly purchased and the tag associated with the product has been logged as being purchased in a database for the retailer that is selling the product. Accordingly, a tag located outside of the tag's home retail space that has not been properly purchased (and not logged as such in a database) is defined as a non-deactivated tag. Further, during a point of sale transaction, data associated with the product and tag in a database may be modified or logged to indicate that the product had been purchased, and thus, upon leaving the retail space, a security gate that still detects the presence of the tag affixed to the product would not trigger an alarm because the product was properly purchased and deactivated, as indicated by the associated data in the database. Additionally, if the product is stolen from a retail space, the trackable device associated with the product is still capable of being read, for example, by a reader outside of the tag's home retail space such as, for example, a reader incorporated into a security gate at another retailer. Regardless of the reason the tag may have left the retail space, because it is still capable of being read and tracked, these tags may still be used to locate or detect the product, if for example, the devices entered a monitoring zone located away from the original retail space (e.g., outside or inside another retail space).

A product having an affixed tag may be referred to as a tagged product. As described, a tagged product may have an RFID tag affixed to it that, in some instances, for example, may be sewn into a product that is a garment, and therefore the tag may travel with garment throughout the garment's useable life, while still being capable of being read by, for example, RFID readers at various retail spaces. In other words, the tag may still be readable after the tag leaves the retail space where the product associated with the tag could have been properly purchased or stolen from (i.e., the product's and tag's “home” retail space). According to various example embodiments, these non-deactivated tags may be read by monitoring systems of foreign or non-home retail spaces (i.e., foreign monitoring systems). Accordingly, some example embodiments may enable the detection of a non-deactivated tag when it enters a monitoring zone that is located outside of and away from the tag's home retail space. As such, when the non-deactivated tags are detected by a monitoring system, example embodiments may include providing an alert to 1) specified store personnel of the retail space from which alerting criteria was received, 2) specified store personnel of an additional retail space which is located close to the monitoring zone in which the tag was detected, 3) local law enforcement, or 4) loss prevention and/or the like. Even further, the information associated with the non-deactivated tags may be aggregated and analyzed so that trends can be detected. This trend analysis may be reported to participating retail spaces and used to recommend theft detection and deterrent actions to those participating retail spaces.

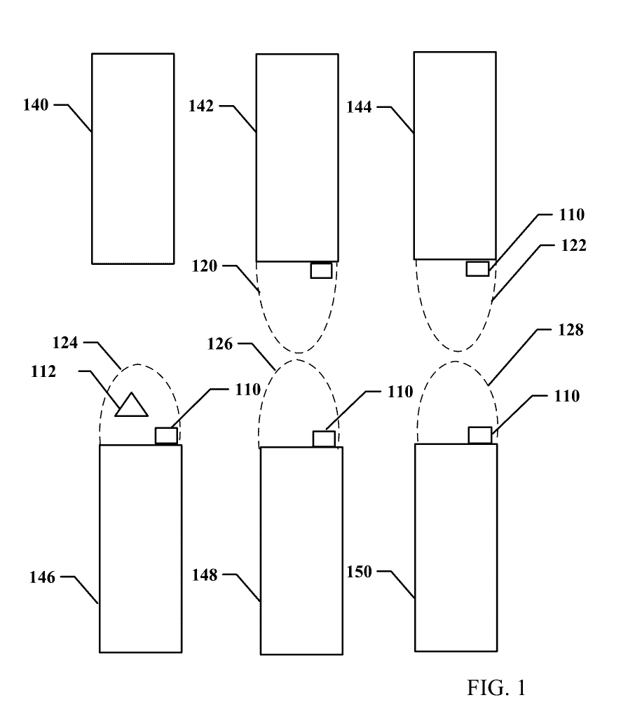

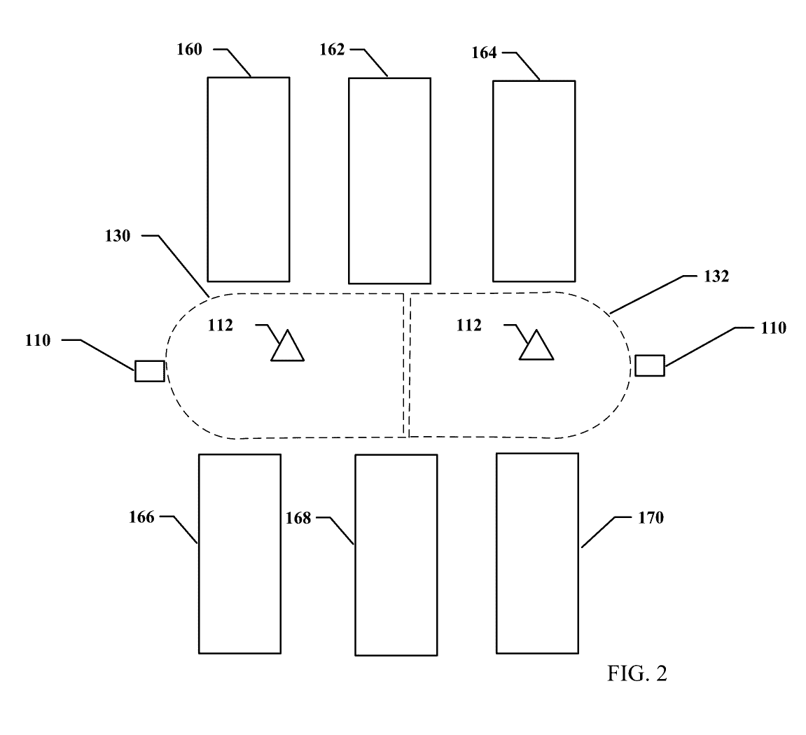

FIG. 1 and FIG. 2 illustrate a block diagram of a pre-determined area located outside a group of retail spaces, where the pre-determined area is divided into monitoring zones in which respective tag readers 110 are located. The tag readers 110 may be employed to detect non-deactivated tags 112 that are disposed on products that enter a monitoring zone located outside a retail space, in accordance with an example embodiment.

As shown in FIG. 1, the area outside a group of retail spaces may be divided up into multiple monitoring zones. For example, there may be a first monitoring zone 120, second monitoring zone 122, third monitoring zone 124, fourth monitoring zone 126, and fifth monitoring zone 128. In some cases, the monitoring zones may be correlated with specific retail spaces. For example, as shown in FIG. 1, the first monitoring zone 120 is located outside a first retail space 142, the second monitoring zone 122 is located outside a second retail space 144, the third monitoring zone 124 is located outside a third retail space 146, the fourth monitoring zone 126 is located outside a fourth retail space 148, and the fifth monitoring zone 128 is located outside a fifth retail space 150.

As shown in FIG. 2, the monitoring zones could alternatively be defined to divide the pre-determined area outside a group of retail spaces into conveniently divided zones 130 and 132 to facilitate detecting non-deactivated tags 112 within the zones, and further detect the tags' 112 movement, between, within, and out of such zones. Thus, monitoring zones may be associated with specific retail spaces, or the monitoring zones may cover multiple retail spaces. Combinations of the above-described ways of defining zones may also be employed.

Further, the combination of a plurality of zones may result in a large overall area that can be monitored. The resulting large overall area may allow for monitoring on a local level (e.g., mall), regional level (e.g., city, cities, or state), or national level states or country), depending on what and how many zones are combined. For example, the zones 120, 122, 124, 126, 128, 130, and 132 shown in FIG. 1 and FIG. 2 could be combined to create a large area capable of being monitored by their respective non-deactivated tag monitors.

Retail spaces interested in participating in the detection of non-deactivated tags outside the home retail space may subscribe to receive alerts once a pre-determined tag is detected, and/or trends and recommended actions associated with the non-deactivated tags. Not all retail spaces in a pre-determined area or monitoring zone have to subscribe in order to facilitate the detection of non-deactivated tags outside a retail space. For example, as shown in FIG. 1, retail spaces 142, 144, 146, 148, and 150 have subscribed to the detection of non-deactivated tags outside their respective retail space and thus received a tag reader 110 for placement on the outside of the retail space. Alternatively, the tag reader 110 may be part of the existing monitoring system for the retail space and simply the read data may be shared. Retail space 140 did not subscribe, and thus, did not receive a tag reader or has chosen not to share read data. Therefore, retail spaces 142, 144, 146, 148, and 150 may receive alerts when a non-deactivated tag is detected in any of monitoring zones 120, 122, 124, 126, or 128, or potentially a larger monitoring zone if these monitoring zones belong to a local, regional, or national monitoring zone.

Further, as shown in FIG. 2, when the predetermined area is divided up into zones not correlated with participating retail spaces, the tag readers 110 may be placed in pre-determined locations in the respective monitoring zone. Therefore, if retail spaces 162, 164, 166, and 168 subscribe to the detection of non-deactivated tags outside their retail spaces, retail spaces 162, 164, 166, and 168 will receive alerts when a non-deactivated tag that meets predefined criteria is detected in any of monitoring zones 130 or 132, or potentially a larger monitoring zone if these monitoring zones belong to a local, regional, or national monitoring zone.

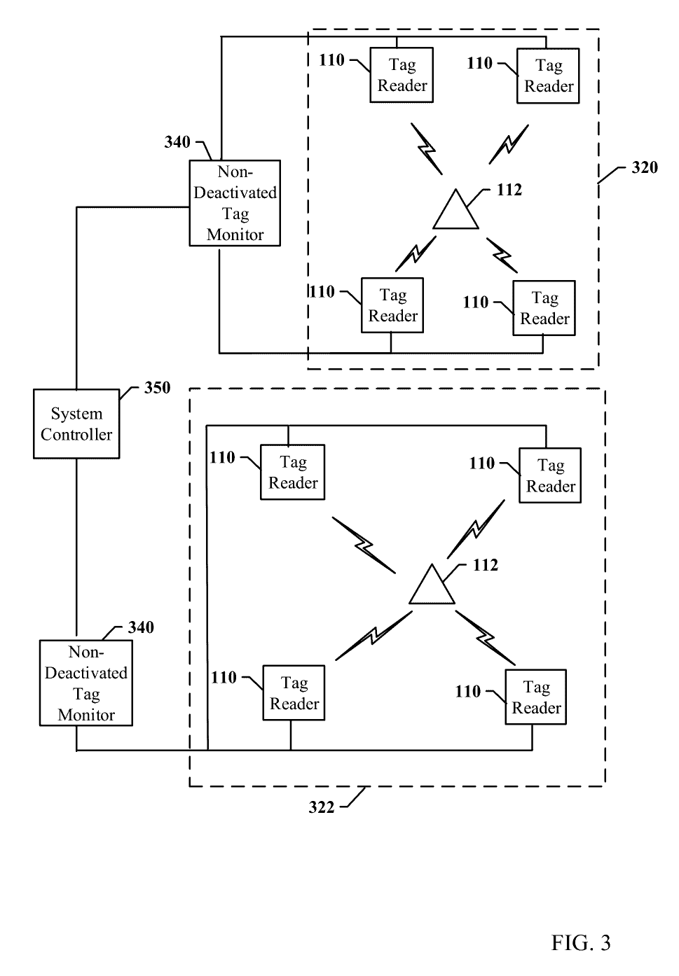

As shown in FIG. 3, a plurality of the tag readers 110, each of which may have corresponding monitoring zones, may be positioned in monitoring regions 320 and 322. These tag readers 110 may communicate with a respective non-deactivated tag monitor 340, where the non-deactivated tag monitor 340 communicates with those tag readers 110 located in a pre-determined geographical location. As used herein, the term non-deactiviated tag monitor 340 refers to an apparatus that functions as described herein, and, for example, links the tag readers 110 for a retail space to a system controller 350 for data aggregation. According to some example embodiments, the non-deactivated tag monitor 340 may be a housed with the tag readers 110 in a central or distributed fashion. Accordingly, there may be a non-deactivated tag monitor 340 associated with a first monitoring region 320, and a further non-deactivated tag monitor 340 associated with a second monitoring region 322. These non-deactivated tag monitors 340 may communicate with a system controller 350 configured to be operably coupled to multiple non-deactivated tag monitors 340 in different regions.

The non-deactivated tag monitor 340 may be a computer, server, or other terminal that may host software and/or hardware configurable to 1) transform the position or presence data associated with the detected non-deactivated tags 112, and the products to which they are attached, into monitoring data so that an alerting function may be triggered either at the non-deactivated tag monitor 340 or system controller 350 and/or 2) aggregate and analyze data associated with the information of tags received from a retail space and tags detected by a tag reader, and the products to which they are attached.

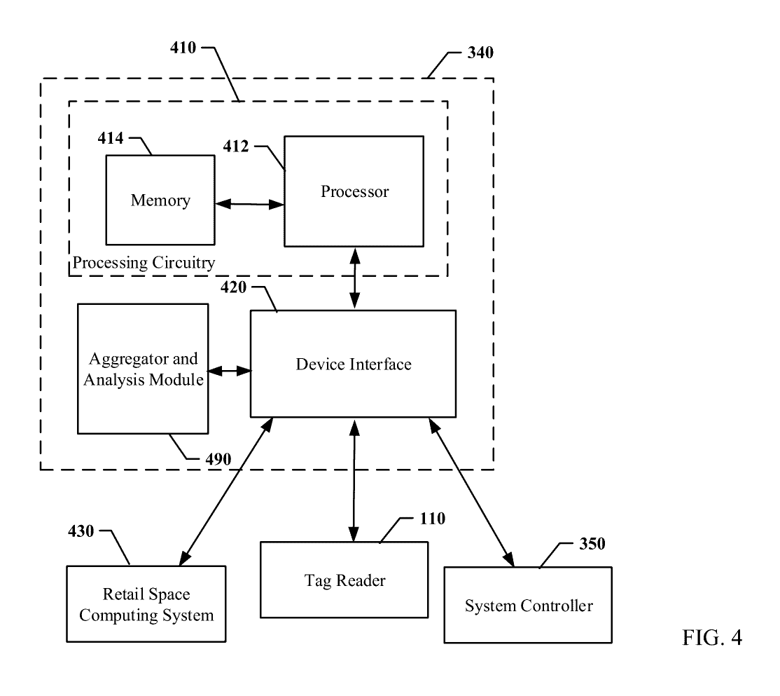

FIG. 4 illustrates a block diagram of a non-deactivated tag monitor in accordance with an example embodiment. As shown in FIG. 4, the non-deactivated tag monitor 340 may include processing circuitry 410 configured in accordance with an example embodiment as described herein. In this regard, for example, the non-deactivated tag monitor 340 may utilize the processing circuitry 410 to provide electronic control inputs to one or more functional units of the non-deactivated tag monitor 340 to receive, transmit, and/or process data associated with the one or more functional units and perform communications necessary to enable detection of tags, perform data aggregation and analysis, issuing of alarms and/or alerts, and/or the like as described herein.

In some embodiments, the processing circuitry 410 may be embodied as a chip or chip set. In other words, the processing circuitry 410 may comprise one or more physical packages (e.g., chips) including materials, components, and/or wires on a structural assembly (e.g., a baseboard). The structural assembly may provide physical strength, conservation of size, and/or limitation of electrical interaction for component circuitry included thereon. The processing circuitry 410 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 410 may include one or more instances of a processor 412 and memory 414 that may be in communication with or otherwise control a device interface 420. As such, the processing circuitry 410 may be embodied as a circuit chip (e.g., an integrated circuit chip) configured (e.g., with hardware, software, or a combination of hardware and software) to perform operations described herein.

The device interface 420 may include one or more interface mechanisms for enabling communication with other devices. These devices may include, but are not limited to, a computing system 430 associated with a retail space, tag reader 110, and system controller 350. In some cases, the device interface 420 may be any means such as a device or circuitry embodied in either hardware, or a combination of hardware and software that is configured to receive and/or transmit data from/to devices or components in communication with the processing circuitry 410 via internal and/or external communication mechanisms. Accordingly, for example, the device interface 420 may further include wireless communication equipment (e.g., one or more antennas) for at least communicating with tag readers 110, computing systems 430 associated with retail spaces, and/or a system controller 350. The device interface 420 may therefore include one or more antenna arrays that may be configured or configurable to receive and/or transmit properly formatted signals associated with the tag readers 110, computing systems 430 associated with retail spaces, and/or system controller 350. The device interface 420 may further include radio circuitry configured to encode and/or decode, modulate and/or demodulate, or otherwise process wireless signals received by or to be transmitted by the antenna array(s).

The processor 412 may be embodied in a number of different ways. For example, the processor 412 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 412 may be configured to execute instructions stored in the memory 414 or otherwise accessible to the processor 412. As such, whether configured by hardware or by a combination of hardware and software, the processor 412 may represent an entity (e.g., physically embodied in circuitry—in the form of processing circuitry 410) capable of performing operations according to embodiments of the present invention while configured accordingly. Thus, for example, when the processor 412 is embodied as an ASIC, FPGA or the like, the processor 412 may be specifically configured hardware for conducting the operations described herein. Alternatively, as another example, when the processor 412 is embodied as an executor of software instructions, the instructions may specifically configure the processor 412 to perform the operations described herein in reference to execution of an example embodiment.

In some examples, the processor 412 (or the processing circuitry 410) may be embodied as, include or otherwise control the operation of the non-deactivated tag monitor 340 based on inputs received by the processing circuitry 410. As such, in some embodiments, the processor 412 (or the processing circuitry 410) may be said to cause each of the operations described in connection with the non-deactivated tag monitor 340 in relation to operation of the non-deactivated tag monitor 340 relative to undertaking the corresponding functionalities associated therewith responsive to execution of instructions or algorithms configuring the processor 412 (or processing circuitry 410) accordingly. In particular, the processor 412 (or processing circuitry 410) may be configured to enable the non-deactivated tag monitor 340 to communicate with the tag readers 110 and/or the computing systems 430 associated with retail spaces to provide information to the system controller 350 that enables the system controller 350 to perform other functions based on the detection of a non-deactivated tag 112 or other information received from the non-deactivated tag monitor 340 that is determinable from the communications with the non-deactivated tag monitor 340.

In an exemplary embodiment, the memory 414 may include one or more non-transitory memory devices such as, for example, volatile and/or non-volatile memory that may be either fixed or removable. The memory 414 may be configured to store information, data, applications, instructions, or the like for enabling the processing circuitry 410 to carry out various functions in accordance with exemplary embodiments of the present invention. For example, the memory 414 may be configured to buffer input data for processing by the processor 412. Additionally or alternatively, the memory 414 may be configured to store instructions for execution by the processor 412. As yet another alternative or additional capability, the memory 414 may include one or more databases that may store a variety of data sets or tables useful for operation of the non-deactivated tag monitor 340. Among the contents of the memory 414, applications or instruction sets may be stored for execution by the processor 412 in order to carry out the functionality associated with each respective application or instruction set. In some cases, the applications/instruction sets may include instructions for carrying out some or all of the operations described in reference to the algorithms or flow charts described herein. In particular, the memory 414 may store executable instructions that enable the computational power of the processing circuitry 410 to be employed to improve the functioning of the non-deactivated tag monitor 340 relative to the functions described herein.

In an example embodiment, the non-deactivated tag monitor 340 may include an aggregator and analysis module 490. The non-deactivated tag monitor 340 may utilize the aggregator and analysis module 490 to aggregate and analyze tag information received from the computing system 430 associated with a retail space or tag reader 110, as further described herein.

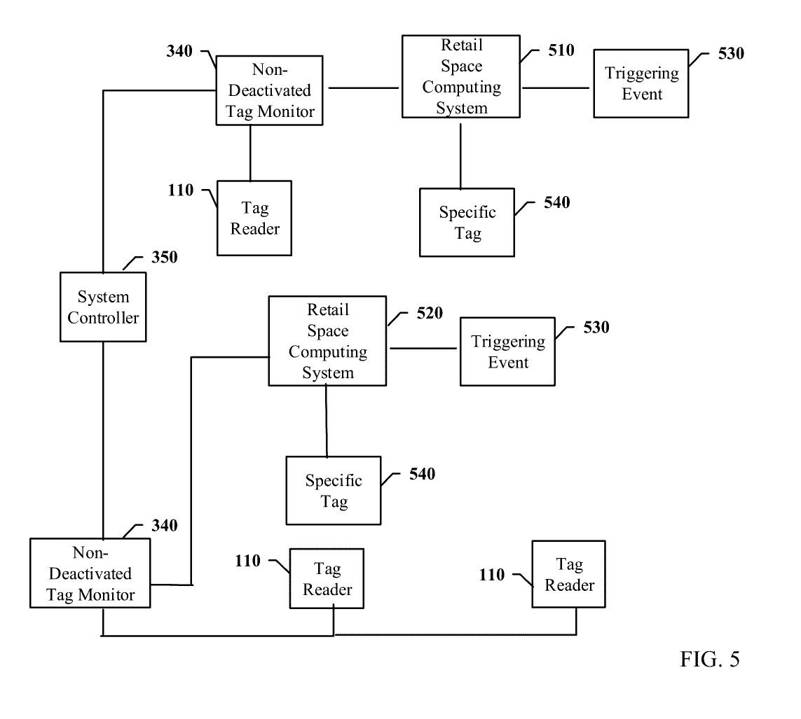

As shown in FIG. 5, the non-deactivated tag monitors 340 may be configured to receive 1) alerting criteria from the computing systems 510 and 520 associated with particular retail spaces in a corresponding geographical location and 2) information from tag readers 110, also in a corresponding geographical location, where such information is indicative of the detection of non-deactivated tags. Based on the detection of the tags, the non-deactivated tag monitor 340 may be configured to determine whether an alerting function should be initiated. In this regard, for example, the non-deactivated tag monitor 340 may reference a table, or other stored repository to determine whether to issue an alert to the participating retail space or computing system associated therewith, and/or the form and content of such an alert.

The alerting criteria may include identification information associated with at least one tag configured to be monitored inside the retail space. As described above, the tag may have an activated and deactivated state, and the tag may be capable of transitioning from the activated state to the deactivated state at a point of sale prior to exiting the retail space. For example, when a tag has an activated state, the tag may be capable of being monitored, tracked, counted, and/or the like inside a retail space. In order to transition the tag to a deactivated state, a database may be modified and a purchase may be logged to transition the tag to being deactivated when the corresponding products are purchased. However, if the tag leaves a retail space without having the tag deactivated, the tag may remain readable and activated. Thus, the tag is still capable of being monitored outside of the home retail space by other monitoring equipment (i.e., the non-deactivated tag monitor 340).

In some cases, the information associated with at least one tag received from the computing system 510 or 520 associated with a retail space may be indicative of a triggering event 530. A triggering event 530 may include store event data. For example, store event data may include events that occur within the retail space such as product purchases, triggered security alarms, or updated inventory counts. Even further, a triggering event 530 may include the detection of a non-deactivated tag, possibly, outside of a retail space (e.g. detecting a non-deactivated tag in a non-home retail space).

Additionally, the identification information associated with at least one tag received from the computing system 510 or 520 associated with a retail space may be associated with a specific tag 540. The identification information associated with a specific tag 540 may include product name or model, brand, description (e.g., size, color, material), care instructions, product category or categories summer dress, children clothing, men's shoes), and/or the like. The specific tag 540 may also be associated with a product the computing system associated with a retail space has identified as lost or stolen. The specific tag 5.40 may also be associated with a list of specific tags associated with products that are on a watch list (e.g., list of priority lost/stolen products). Combinations of the above-described alerting criteria may also be received from a retail space. Even further, the alerting criteria may be received and updated in real time, daily, or any other time period as may be determined by the system controller 350, non-deactivated tag monitor 340, or the computing system 510 or 520 associated with the retail space.

The alerting function may be initiated when the non-deactivated tag monitor 340 compares the alerting criteria to the identification information associated with at least one tag detected by a tag reader 110. When an alert is issued, the location of the tag 112 and the movement of the tag 112 may be monitored while the tag 112 remains within a monitored area. However, in sonic cases, the alert may simply record the detection of a tag 112 in a corresponding one of the zones.

The alerting function may include alerting 1) specified store personnel of the computing system associated with the retail space from which alerting criteria was received, 2) specified store personnel of an additional computing system associated with the retail space which is located close to the monitoring zone in which the tag was detected, 3) local law enforcement, or 4) loss prevention and/or the like. The alerting function may further include alerting the aggregator and analysis module 490 so that the information associated with the tag 112 may be aggregated and analyzed, as described below.

The non-deactivated tag monitor 340 may also be configured to aggregate and analyze the information associated with non-deactivated tags received from the computing system 510 or 520 associated with a retail space or detected by the tag reader 110. The aggregation and analysis of information associated with non-deactivated tags received from the computing system of a retail space may result in the non-deactivated tag monitor 340 detecting trends in the information, reporting the trends to a retail space, and recommending actions to detect and deter theft.

For example, the non-deactivated tag monitor 340 may be capable of determining what products are frequently reported lost or stolen or what products have recently been reported as lost or stolen. Further, the non-deactivated tag monitor 340 may be capable of determining how often store alarms are triggered, the days and times in which alarms are triggered, and what area or zone of the store triggers the alarm. Even further, the non-deactivated tag monitor 340 may be capable of determining whether the weather or specific holidays affect the frequency of triggered alarms or the reporting lost or stolen items.

Additionally, the movement of non-deactivated tags outside of a retail space or spaces, along with information associated with the non-deactivated tag such as product type, may be analyzed to detect patterns of behavior for organized crime groups. Combinations of the above-described ways of aggregating and analyzing the information may also be employed. The above trend analysis may result in the non-deactivated tag monitor recommending actions to participating retail spaces. These recommended actions may include adding more store personnel during high theft times or at high theft locations, additional security protection for high-theft items, or additional tracking of high theft items while in the retail space.

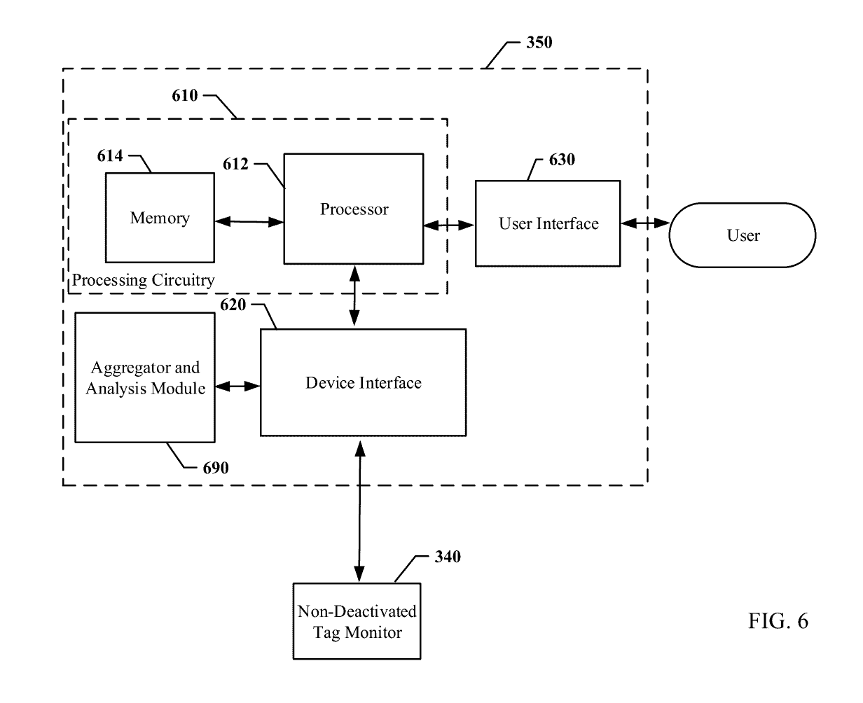

FIG. 6 illustrates a block diagram of the system controller 350 in accordance with an example embodiment. The system controller 350 may be configured to communicate with at least one non-deactivated tag monitor.

As shown in FIG. 6, the system controller 350 may include processing circuitry 610 of an example embodiment as described herein. In this regard, for example, the system controller 350 may utilize the processing circuitry 610 to provide electronic control inputs to one or more functional units of the system controller 350 to obtain, transmit, and/or process data associated with the one or more functional units and perform the subsequent locating, tracking, notification, aggregation, analysis, and/or alarm functions described herein. In some embodiments, the processing circuitry 610 may be embodied in physical and functional form in a similar manner to that which has been described above. In some cases, the processing circuitry 610 may have expanded capability.

As further shown in FIG. 6, the system controller 350 may include an aggregator and analysis module 690. In sonic embodiments, an aggregator and analysis module 690 may be embodied in physical and functional form in a similar manner to that which has been described above. In some cases, an aggregator and analysis module 690 may have expanded capability. For example, the aggregator and analysis module 690 may be further utilized by the system controller 350 to control subscription service related activities. In particular, it may he configured to decide what type of trend analysis, data, or recommended actions should be sent to a participating retail space based on the retail space's subscription level. If the retail space is subscribed to national level monitoring, the retail space may receive analysis and recommended actions based on all information associated with the monitoring zones in that level. If the retail space is subscribed to local level monitoring, the retail space may receive analysis and recommended actions based only on information associated with the monitoring zones in that level.

The system controller 350 may be configured to execute the operations described above for the non-deactivated tag monitor 340. In an example embodiment, the system controller 350 and/or non-deactivated tag monitor 340 may therefore be configured to receive information from a tag reader 110 or the computing system 430 associated with a retail space, and make decisions on issuing alerts or aggregating and analyzing data as described above. When the non-deactivated tag monitor 340 is not implemented at the system controller 350, the non-deactivated tag monitor 340 may receive information from the tag readers 110 and computing systems 430 associated with retail spaces and may process the information remotely and act accordingly based on the information. When the non-deactivated tag monitor 340 and the system controller 350 split functions, the non-deactivated tag monitor 340 and system controller 350 may communicate cooperatively to execute example embodiments.

From a technical perspective, the non-deactivated tag monitor embodied either separately or at the system controller 350 described above, may be used to support some or all of the operations described above. As such, the platforms described in FIGS. 1-6 may be used to facilitate the implementation of several computer program and/or network communication based interactions.

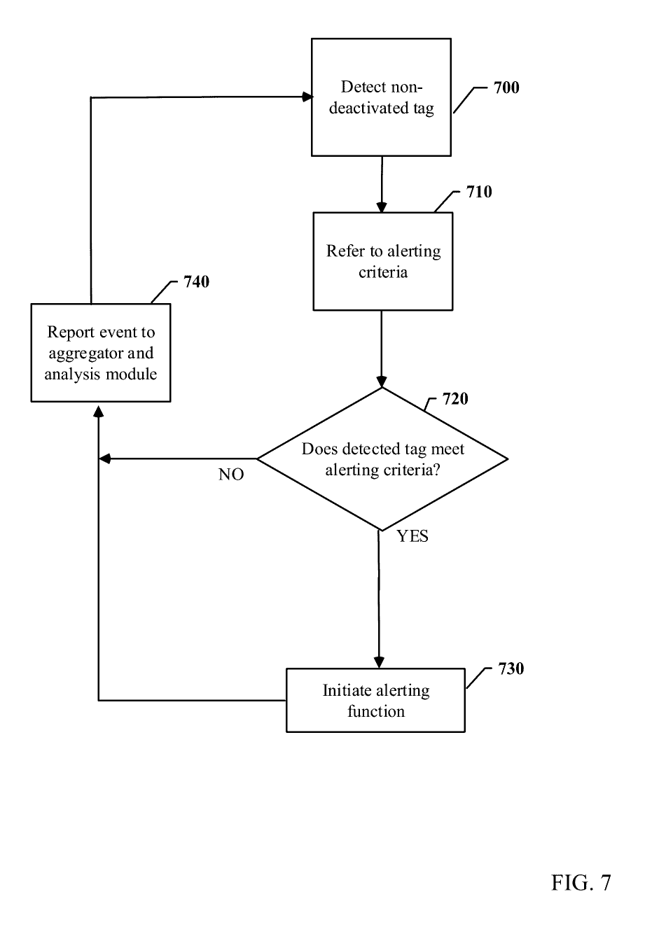

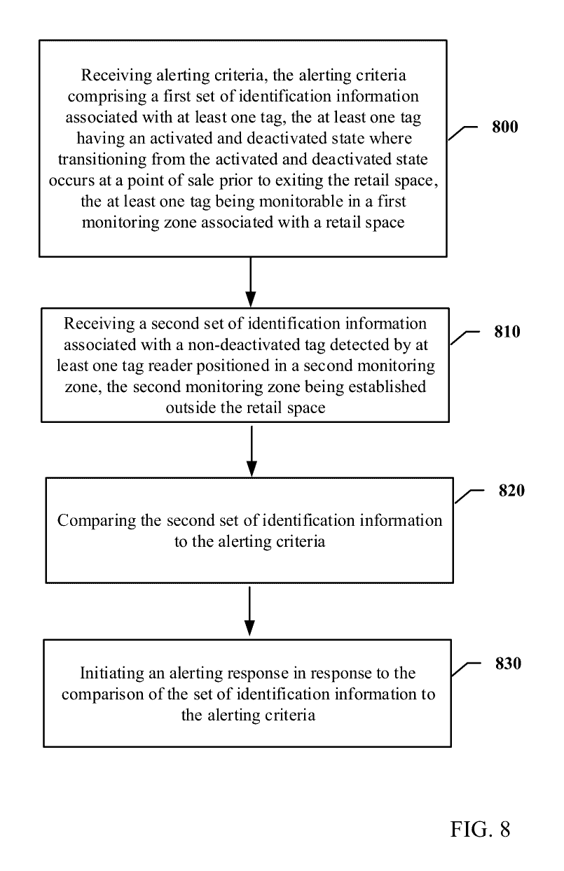

As an example, FIGS. 7-8 are flowcharts of example methods and program products according to example embodiments of the invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may he embodied by computer program instructions. In this regard, the computer program instructions which embody the procedures described above may he stored by a memory device of a user terminal and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to he performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, FIG. 7 illustrates a block diagram showing a control flow representative of an algorithm executable at the non-deactivated tag monitor 340 (or executable at a system controller 350) in accordance with an example embodiment. As shown in FIG. 7, the non-deactivated tag monitor may initially receive information indicative of detection of a non-deactivated tag at operation 700. As discussed above, the information may be routine tracking information associated with one of the monitoring zones. The non-deactivated tag monitor may refer to the alerting criteria at operation 710. A determination may then be made at operation 720 as to whether an alert should be initiated. As an example, a determination may be made to see if the detected tag matches the alerting criteria. If it does not, operation 710 is repeated for each new tag detected. However, if the detected tag matches the alerting criteria, then initiation of the alerting function may be conducted at operation 730. Regardless of whether an alerting function is initiation, information associated with the non-deactivated tag may be reported to the aggregator and analysis module at operation 740.

FIG. 8 illustrates a block diagram of a method for detecting a non-deactivated tag in accordance with an example embodiment. The tag may be associated with a corresponding product (e.g., retail item) in a monitoring environment. The method may be executed by a non-deactivated tag monitor that may be configured to interface with a tag reader. The non-deactivated tag monitor may include processing circuitry configured to perform the method of FIG. 8. The method may include receiving the alerting criteria from at least one computing system associated with a retail space at operation 800. The method may further include receiving identification information of a detected tag from at least one tag reader disposed in a monitoring zone at operation 810. The method may further include comparing the information received from the tag reader to the alerting criteria at operation 820. The method may further include initiating an alerting function responsive to the alerting criteria being met at operation 830.

In some embodiments, the features described above may be augmented or modified, or additional features may he added. These augmentations, modifications and additions may be optional and may he provided in any combination. Thus, although some example modifications, augmentations and additions are listed below, it should be appreciated that any of the modifications, augmentations and additions could be implemented individually or in combination with one or more, or even all of the other modifications, augmentations and additions that are listed. Example embodiments described herein may enhance security in direct and indirect ways, therefore effectiveness and overall cost to a retailer using instances of security devices to protect products may be reduced.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to he limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases Where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A tag monitor comprising processing circuitry configured to:
receive alerting criteria, the alerting criteria being based on a first set of identification information associated with at least one tag, the at least one tag having an activated and deactivated state wherein transitioning from the activated to deactivated state occurs at a point of sale prior to exiting the retail space, the at least one tag configured to be monitored in a first monitoring zone associated with a retail space;
receive a second set of identification information associated with a non-deactivated tag detected from at least one tag reader positioned in a second monitoring zone, the second monitoring zone being located outside the retail space;
compare the second set of identification information to the alerting criteria; and
initiate an alerting response in response to the comparison of the second set of identification information to the alerting criteria.

2. The tag monitor of claim 1, wherein the alerting criteria associates entry of a first set of identification information with a corresponding trigger.

3. The tag monitor of claim 1, wherein the first set of identification information is indicative of a specific tag reported by a computing system associated with the retail space.

4. The tag monitor of claim 3, wherein the first set of identification information indicates whether the at least one tag is a non-deactivated tag.

5. The tag monitor of claim 3, wherein the first set of identification information indicates whether the at least one tag is associated with a product on a watch list.

6. The tag monitor of claim 1, wherein the first set of identification information is indicative of a triggering event.

7. The tag monitor of claim 6, wherein the second set of identification information defines store event data, and wherein the tag monitor is further configured to, in response to the store event data matching the triggering event, initiate the alerting response.

8. The tag monitor of claim 1, wherein being configured to initiate the alerting response includes being configured to initiate the alerting response in at least one-predetermined retail space.

9. The tag monitor of claim 8, wherein the at least one-predetermined retail space is associated with a subscriber enrolled in a subscription service, wherein the subscriber is associated with the second monitoring zone.

10. A method of monitoring a non-deactivated tag comprising:
receiving alerting criteria, the alerting criteria comprising a first set of identification information associated with at least one tag, the at least one tag having an activated and deactivated state wherein transitioning from the activated to deactivated state occurs at a point of sale prior to exiting the retail space, the at least one tag configured to be monitored in a first monitoring zone associated with a retail space;
receiving a second set of identification information associated with a non-deactivated tag detected by at least one tag reader positioned in a second monitoring zone, the second monitoring zone being established outside the retail space;
comparing the second set of identification information to the alerting criteria; and
initiating an alerting response in response to the comparison of the set of identification information to the alerting criteria.

11. The method of claim 10, wherein the alerting criteria associates entry of a first set of identification information with a corresponding trigger.

12. The method of claim 10, wherein the first set of identification information is indicative of a specific tag reported by a computing system associated with the retail space.

13. The method of claim 12, wherein the first set of identification information indicates whether the at least one tag is a non-deactivate tag.

14. The method of claim 10, wherein the first set of identification information is indicative of a triggering event.

15. The method of claim 14, wherein the second set of identification information defines store event data, and wherein the tag monitor is further configured to, in response to the store event data matching the triggering event, initiate the alerting response.

16. The method of claim 10, wherein being configured to initiate the alerting response includes being configured to initiate the alerting response in at least one-predetermined retail space.

17. A system for monitoring tags, the system comprising:
a plurality of tag readers associated with a second monitoring zone; and
a non-deactivated tag monitor comprising processing circuitry configured to:
receive alerting criteria, the alerting criteria comprising a first set of identification information associated with at least one tag, the at least one tag having an activated and deactivated state Wherein transitioning from the activated to deactivated state occurs at a point of sale prior to exiting the retail space, the at least one tag configured to be monitored in a first monitoring zone associated with a retail space;
receive a second set of identification information associated with a non-deactivated tag detected by at least one tag reader positioned in a second monitoring zone, the second monitoring zone being established outside the retail space;
compare the second set of identification information to the alerting criteria; and
initiate an alerting response in response to the comparison of the set of identification information to the alerting criteria.

18. The system of claim 17, further comprising an aggregation and analysis module.

19. The system of claim 18, wherein the aggregation and analysis module is located at the non-deactivated tag monitor.

20. The system of claim 18, where the aggregation and analysis module is located at a system controller, wherein the system controller is configured to receive information from a plurality of non-deactivated tag monitors, and wherein each non-deactivated tag monitor is associated with different geographical locations.
